(19) United States
(12) Patent Application Publication
(10) Pub. No.: US 2025/0334167 A1
(43) Pub. Date: Oct. 30, 2025

(54) TORSIONAL VIBRATION REDUCING APPARATUS

(71) Applicant: UNIPRES CORPORATION, Yokohama-shi, Kanagawa (JP)

(72) Inventors: Daiki KAKEHI, Fuji-shi (JP); Yutaka MURATA, Fuji-shi (JP); Atsushi KOBAYASHI, Fuji-shi (JP); Ryuta MORI, Fuji-shi (JP)

(73) Assignee: UNIPRES CORPORATION, Yokohama-shi, Kanagawa (JP)

(21) Appl. No.: 18/859,634

(22) PCT Filed: Jan. 20, 2023
(86) PCT No.: PCT/JP2023/001704

§ 371 Date: Jun. 25, 2025

(51) Int. Cl. F16F 15/123

(52) U.S. Cl. CPC F16F 15/12346; F16F 15/12326; F16F 15/1236

(57) ABSTRACT

According to the present invention, in a rotational fluctuation reducing apparatus, a serial connection formed, via an intermediate retainer 36, between a low-rigidity first coil spring 32 and a high-rigidity second coil spring 34 is disposed between the first retainer 16 and the second retainer 18 which form a pair, which are spaced apart from each other in the circumferential direction, and which are made of resin material. The first coil spring 32 and the intermediate retainer 36 are disposed in a bottomed recess 40 of the first retainer 16. During deformation, the intermediate retainer 36 is caused to slide at a radially outer portion of the bottomed recess 40 of the first retainer 16. The second coil spring 34 is contained in a bottomed recess 42 of the second retainer 18. Damping control is performed, in a low-torque range, under low torsional rigidity resulting from the serial connection of the first coil spring 32 and the second coil spring 34, and is performed, in a normal torque range, under high torsional rigidity provided solely by the second coil spring 34. The present invention achieves reduction in abnormal noise due to switching taking place through resin-metal contact and low noise during the idling.

### TECHNICAL FIELD

The present invention relates to a torsional vibration reducing apparatus for reducing a torsional vibration of a rotating shaft of a prime mover by connecting a low-rigidity coil spring and a high-rigidity coil spring in series.

### BACKGROUND ART

As a technique for obtaining a wide range of a torsional angle at a low rigidity state for the purpose of reducing a noise during idling and so on, a two-stage operation torsional-vibration reducing apparatus arranged the low-rigidity coil spring and the high-rigidity coil spring in series, is known (Patent Document 1 and Patent Document 2). A series arrangement between the low-rigidity coil spring and the high-rigidity coil spring is located between opposite surfaces in the rotational direction at a rotating plate of the engine side and a rotating plate of the transmission side.

In a state that the torsional angle of the input-output axes is small, the low-rigidity coil spring and the high-rigidity coil spring work in series, the increasing of the torque to the increasing of the torsional angle becomes small since the torsional rigidity as composite value becomes small. Therefore, it is possible to suppress the increasing of the torsional torque over a wide range of the torsional angle.

When the vehicle shifts from an idling drive to a driving with the rated torque for the normal running and the torsional torque increases to the limit value (just before to the complete crushing or the adhesion), the low-rigidity coil spring is disabled, the high-rigidity coil spring is independently worked to the torsional torque, and the increasing of the torsional torque to the torsional angle becomes great compared to the case of the series connection of the coil springs.

In order to realize the above operations, in the technique of Patent Document 1, the low-rigidity coil spring is located in radial inner side and the high-rigidity coil spring is located in radial outer side, respectively. In the low torque range, a rotation of a hub at the radial inner side is transmitted to a clutch plate via the low-rigidity coil spring, and it is possible to obtain the low torsional rigidity based on the series connection of the low-rigidity coil spring and the high-rigidity coil spring. In the high torque range, the low-rigidity coil spring is disabled by rotating and constraining the hub to the clutch plate, and the high torsional rigidity is obtained with an attenuation operation based on only the high-rigidity coil spring.

Also, in the technique of Patent Document 2, the low-rigidity coil spring and the high-rigidity coil spring are connected in series via the supporting plate in the low torque range, and the low-rigidity coil spring is disabled by rocking to an input side or an output side of the supporting plate in the high torque range. Although the unaccompanied operation of the high-rigidity coil spring is the same as Patent Document 1, there are points of constructional differences that the low-rigidity coil spring and the high-rigidity coil spring are located on the same circumference.

### THE LIST OF PRIOR ART DOCUMENTS

### Patent Documents

Patent Document 1: Japanese Unexamined Patent Publication No.H09 (1997)-42311 A
Patent Document 2: Japanese Unexamined Patent Publication No.2015-161371 A

### SUMMARY OF THE INVENTION

### Problems to be solved by the Invention

In the conventional technique, the hub and the supporting plate to control the connection between the low-rigidity coil spring and the high-rigidity coil spring are the body components made of metal, which are arranged by occupying a whole circumference in coaxial to the input-output axes and occupy a large space which cannot be overlooked in the whole damper device. Therefore, a dedicated part for mounting and positioning is additionally necessary in addition to the low-rigidity coil spring, and it is not possible to avoid the problems that the cost becomes up based on the increased numbers of the parts and increased numbers of assembling steps. Moreover, the invalidation of the low-rigidity coil spring when the connection is switched from the series connection of the low-rigidity coil spring and the high-rigidity coil spring to the single operation of the high-rigidity coil spring depends on the engagement between the hub and the clutch plate or the engagement between the supporting plate and the rotating member on the input side or the output side, and the direct contact between metal and metal will result in the generation of loud noises.

The present invention has been developed in view of the above-described technical problems of the prior art, and an object of the present invention is to perform a damper, which has the series connection with the low-rigidity coil spring and the high-rigidity coil spring, by the minimum increasing of the parts and to enhance a compatibility of noise countermeasures.

### Means for Solving the Problems

In order to accomplish the present invention, a torsional vibration reducing apparatus that comprises an input member for rotating and connecting to a driving side, an output member having a rotation central line with the input member and for rotating and connecting to a driven side, and an elastic body arranged in a circumferential direction between the input member and the output member; and reduces a rotational fluctuation based on an elastic deformation of the elastic body in the circumferential direction at a time of driving of the output member on the driven side by the input member of the driving side,
wherein one of the input member and the output member comprises guide portions, arc-extending, which is faced to the elastic body from outside and has the rotation central line of the input member and the output member, another of the input member and the output member comprises a center supporting plate and overhang boards extending between the elastic body adjacent to the circumferential direction of the supporting plate and the elastic body, the respective guide portions form an engaging portion extended in diameter inside on both circumferential direction ends, and respective overhang boards form a pressurization section extended in diameter outside on the both circumferential direction ends;
wherein the torsional vibration reducing apparatus further comprises supporting structures in an axial direction and a radial direction to the input member and/or the output member arranged in circumferential direction ends of the respective elastic bodies, and retainers being movable to the circumferential direction along the guide portions; the retainers have bottomed recesses for respectively containing opposite ends to the circumferential direction of the elastic bodies, and the retainers are opposed and arranged to the engaging portions adjacent to the guide portions and pressurization sections adjacent to the overhang boards in pressure receiving sections which are side ends separated from the bottomed recess in the circumferential direction;
wherein the elastic body comprises a low-rigidity first elastic member, a high-rigidity second elastic member and an intermediate member for connecting the first elastic member and the second elastic member in series with regard to at least one end of the retainers, and the first elastic member, the intermediate member and side ends adjacent to intermediate member of the second elastic member are contained in the bottomed recesses of the corresponding retainers, and the intermediate member is slidably supported to an opposite surface in a radial direction of the bottomed recess of the retainers; and
wherein in the retainers being a pair, the retainer located at an upstream in a torque transmission direction is circumferentially moved, by making contact with the pressurization section adjacent in the circumferential direction, along the guide portion toward the retainer located at a downstream in the torque transmission direction and engaged with the engaging portion adjacent to the guide portion, against a low elastic force based on a serial combination of an elastic modulus of the first elastic member and an elastic modulus of the second elastic member in a transmission torque range lower than a rated use, and against a high elastic force based on the high elastic modulus of the second elastic member alone in a rated transmission torque range.

In order to accomplish the present invention, wherein the first elastic member and the second elastic member are configured as the first coil spring and the second coil spring respectively; and comprise the first holding part doing the holding of the first coil spring without bottoming out before transitioning to the second coil spring sole operation, and the second holding part holding side ends adjacent to the first coil spring of the second coil spring when sliding the retainer of the intermediate member on a series and standalone operations.

In order to accomplish the present invention, wherein the first holding part comprises a small diameter portion formed on a center portion in a bottom surface of the bottomed recess of the retainer and contained one end of the first coil spring from outer diameter side, and a projection formed on the second coil spring separation surface of the intermediate member and inserted into another end of the first coil spring; wherein the first holding part comprises a small diameter portion formed on a center portion in a bottom surface of the bottomed recess of the retainer and contained one end of the first coil spring from outer diameter side, and a recess formed on the second coil spring separation surface of the intermediate retainer and contained another end of the first coil spring; and wherein the first holding part comprises a projection formed on a center portion in a bottom surface of the bottomed recess of the retainer and inserted into one end of the first coil spring from outer diameter side, and a recess formed on the second coil spring separation surface of the intermediate retainer and contained another end of the first coil spring.

In order to accomplish the present invention, wherein the second holding part holds the second coil spring in the first coil spring separation side of the intermediate member by making contact on the inner diameter portion in the first coil spring near side end of the second coil spring, and is a visor which is slidably made contact with inner surface of the bottomed recess of the retainer in the circumferential direction; wherein the second holding part is a conical pedestal-shape projection inserted into a center opening portion of the second coil spring in the first coil spring separation side of the intermediate retainer; and wherein at least the first retainer and the second retainer out of the intermediate retainer, the first retainer and the second retainer are moldings made by injection molding as a material of synthetic resin.

In order to accomplish the present invention, wherein the supporting structure is formed on opposite-face surfaces between the input member and the output member of the first retainer and the second retainer and is constituted as a self-contained type supporting structure made by a groove-projection fitting structure and a surface-surface contacting structure for supporting the first retainer and the second retainer themselves in the axial direction and the radial direction to the input member and the output member, and wherein relative displacements of the input member and the output member according to rotational fluctuation arouse relative displacements in the circumferential direction according to elastic force between the first retainer and the second retainer.

In order to accomplish the present invention, wherein the supporting structure is configured as an axially aligned structure of multiple plates in which one of the input member and the output member is disposed between the other of the input member and the output member in order to support the first retainer and the second retainer in the axial direction and the radial direction, and wherein relative displacements of the input member and the output member according to rotational fluctuation arouse relative displacements in the circumferential direction according to elastic force between the first retainer and the second retainer.

### Effects of the Invention

According to the torsional vibration reducing apparatus of the present invention, a low-rigidity first elastic member and an intermediate member to connect the first elastic member to the second elastic member are contained in the first retainer and/or the second retainer, and deformation of the first elastic member and/or the second elastic member can be accommodated by sliding the retainer-opposite surface of the intermediate member. Consequently, a metal rotating member arranged coaxially with the transmission rotation center and additional metal parts for engaging the elastic member in the prior art become unnecessary, and it is possible to obtain the significant reduction in the number of parts and a significant cost reduction due to a shortened labor cost.

The first retainer and the second retainer are relatively large since they have the structure to contain the end portions of the elastic member, and can be made into resin parts by selecting the appropriate material. Further, the connecting member may be made of the metal, but this can also be made into the resin parts by selecting the appropriate material. Then, since the contact can be made between the resin vs the metal or the resin vs the resin when the connecting member seats at a switching time between the low rigidity and the high rigidity, it is possible to significantly reduce an abnormal noise caused by the shock at the switching time.

### BRIEF DESCRIPTION OF THE DRAWINGS

In the accompanying drawings:

FIG. 1 is a front view of a torsional vibration reducing apparatus according to the first embodiment as viewed from a transmission side;

FIG. 2 is a back view of the torsional vibration reducing apparatus according to the first embodiment as viewed from a prime mover side;

FIG. 3 is an arrow cross sectional view along III-III line in FIG. 1;

FIG. 4A shows left half of a perspective view of the torsional vibration reducing apparatus according to the first embodiment in the disassembled state;

FIG. 4B shows right half of the perspective view of the torsional vibration reducing apparatus according to the first embodiment in the disassembled state;

FIG. 5A is a sectional view of the first retainer and the second retainer to form a counterpart, a coil spring set comprising the first coil spring, the second coil spring and an intermediate retainer between them according to the torsional vibration reducing apparatus of the first embodiment, and the coil spring set shows an initial set state;

FIG. 5B is a sectional view of the first retainer and the second retainer to form a counterpart and the coil spring set similar to FIG. 5A, however, the coil spring set shows the state at the switching time from the first low-rigidity coil spring to the second high-rigidity coil spring;

FIG. 5C is a sectional view similar to FIGS. 5A and 5B, however, shows the state when the first retainer and the second retainer are made contact;

FIG. 6 is a graph schematically showing a relationship between a torsional angle and a torsional torque according to the coil spring set of the first embodiment;

FIG. 7 is a sectional view of the first retainer and the second retainer to form a counterpart, the coil spring set comprising the first coil spring, the second coil spring and the intermediate retainer between them according to an another embodiment, and the coil spring set shows an initial set state;

FIG. 8 is similar to FIG. 7, however, shows another embodiment;

FIG. 9 is similar to FIGS. 7 and 8, however, shows another embodiment;

FIG. 10 is a front view of a torsional vibration reducing apparatus according to the second embodiment as viewed from the transmission side;

FIG. 11 is an arrow cross sectional view along XI-XI line in FIG. 10;

FIG. 12 is an arrow cross sectional view along XII-XII line in FIG. 10; and

FIG. 13 is a sectional view of the first retainer and the second retainer to form a counterpart, a coil spring set comprising the first coil spring, the second coil spring and the intermediate retainer between them according to the torsional vibration reducing apparatus of the second embodiment, and the coil spring set shows the initial set state.

### MODE FOR CARRYING OUT THE INVENTION

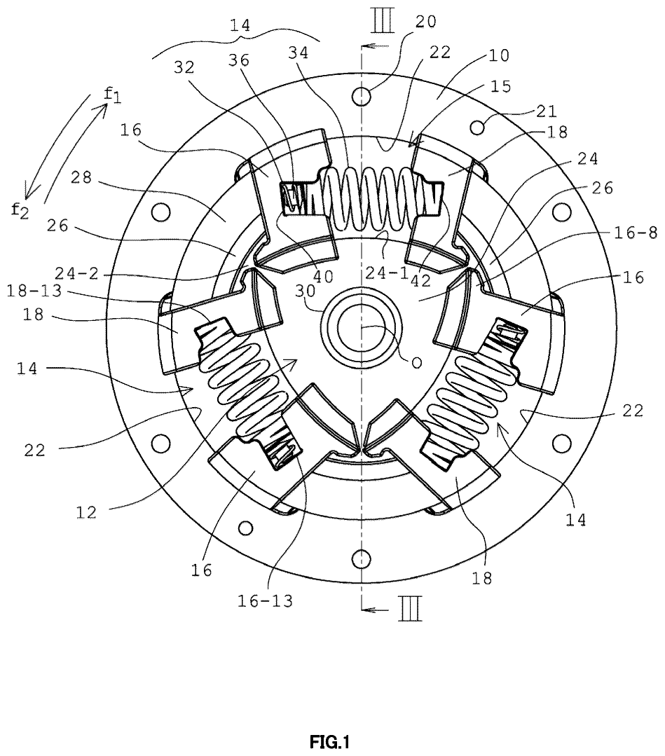

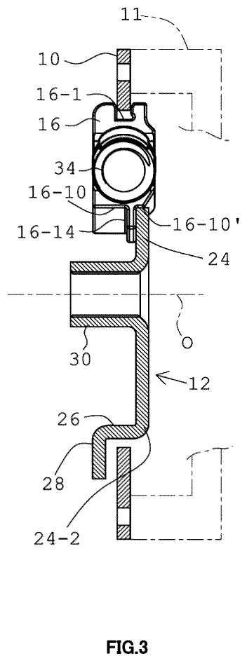

The embodiments of the present invention will be described with reference to the accompanying drawings. FIGS. 1 to 3 show a torsional vibration reducing apparatus according to the first embodiment at an assembled state, in which both the input member and the output member are press-formed products from a single steel plate, and the retainer for holding the end portions of the coil springs is provided with a supporting function for the input member and the output member by itself. The torsional vibration reducing apparatus comprises an input member 10 connected to a flywheel (the one part shown by an imaginary line 11 in FIG. 3) connected to a crank shaft (the driving side of the present invention) of an internal-combustion engine (a prime mover), an output member 12 connected to the transmission (the driven side of the present invention), coil spring sets 14 (an elastic body of the present invention) multiple (three pieces in the embodiment) arranging at equal intervals in a circumferential direction, the first retainer 16 located in one end of the length direction (the circumferential direction) of the respective coil spring sets 14, and the second retainer 18 located at other end of the length direction (the circumferential direction) of the respective coil spring sets 14. Therefore, three sets of the first retainer 16 and the second retainer 18 are provided in a line with the numbers of the coil spring sets 14.

The respective coil spring sets 14 are constructed by connecting the first coil spring 32 (the first elastic member of the present invention) having the low-rigidity and the short length and the second coil spring 34 (the second elastic member of the present invention) having the high-rigidity and the long length in series through an intermediate retainer 36 (an intermediate member of the present invention).

The first retainer 16 and the second retainer 18 are plastic molded products such as nylon resin and so on, and they respectively have self-contained type supporting structures, as stated below, which can support themselves in both axial direction and radial direction to the input member 10 and the output member 12 without damaging the original function such as retaining the ends of the coil spring sets 14. The intermediate retainer 36 can be made by pressing the metal plate of an appropriate thickness from the viewpoint of the cost and can also be made of the resin by appropriately selecting the material or the wall thickness. This is advantage in the point of reducing the noise since the switching between the low-rigidity and the high-rigidity is a collision of the resin vs the resin.

The input member 10 is a press-formed product of which the material is the steel plate and is configured as an annular disc. The input member 10 has bolt holes 20 for fixing to six fly wheels arranged at the equal intervals in a circumference direction on the outer periphery, and has two knock pin holes 21 of which diameter is smaller than the volt hole 20 and which are arranged in diameter opposite positions (to avoid the complex, only one drawing number is shown).

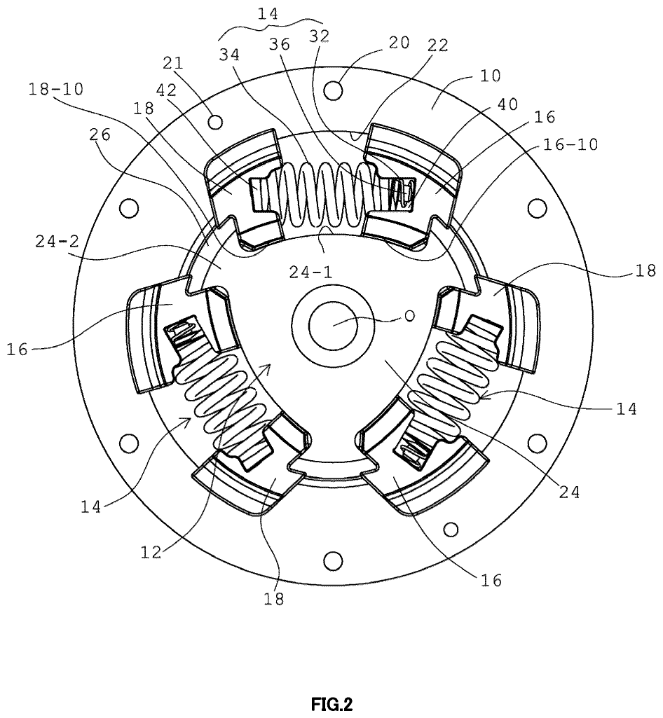

Guide portions 22 which are arc-like and specified depth recessed parts are formed on the inner circumferential surface of the input member 10 at the equal intervals in the circumferential direction. The group of the first retainers 16 and 18 is arranged on each of the guide portions 22 as shown in FIGS. 1 and 2. The inner peripheral concave-surface of the input member 10 forming the guide portions 22 has a rotation center aligned with the rotation central line O of the input-output axes and forms a sliding guide surface of the first retainers 16 and 18 at a time of the torsional vibration between the input-output axes as explained below. The respective groups of the retainers 16 and 18 are arranged in both circumferential direction ends of the corresponding guide portions 22 at close and opposed.

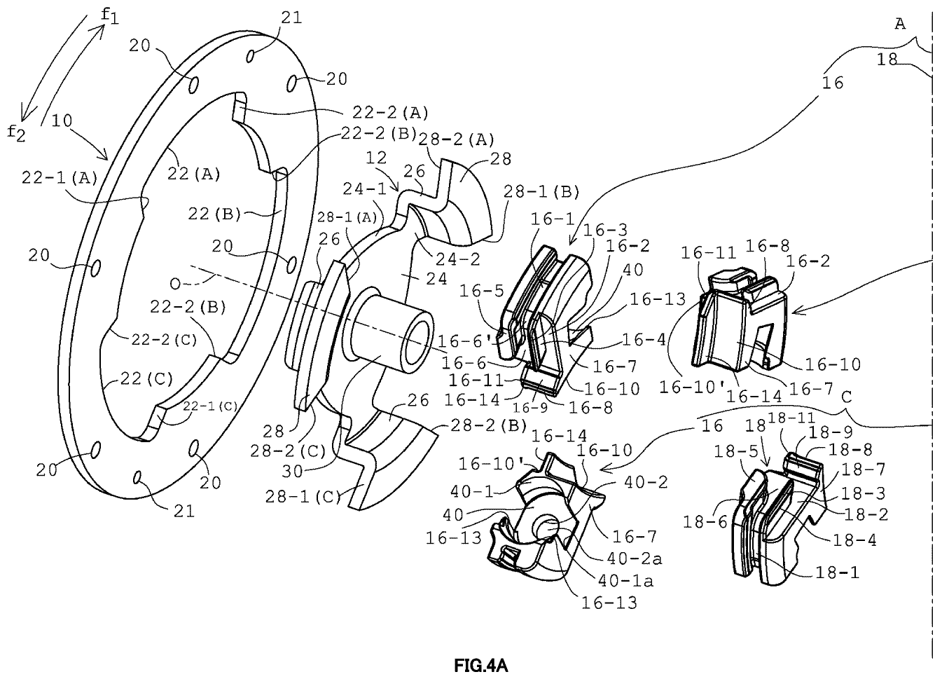

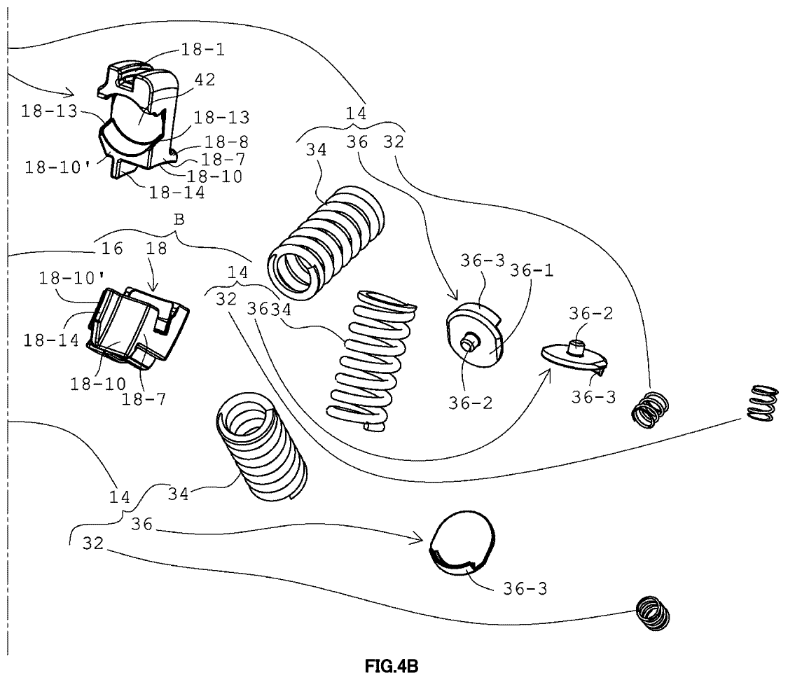

The output member 12 (also refer to FIG. 4A with regard to the shape) is also the press molded product of which the material is the steel plate similar to the input member 10, and comprises, as shown in FIG. 1, a supporting plate 24 of which the shape is roundish and pseudo triangular (Onigiri (Japanese) shape) and three overhang boards 28 generally bent and formed from an outer peripheral convex portion 24-2 with regard to the triangular shape top of the supporting plate 24. The respective overhang boards 28 are arranged between coil spring sets 14 mutually adjacent in the circumferential direction. The output member 12 further forms an integrated spline shaft 30, which is coaxial to the rotation central line O of the input-output axes, on the center part of the overhang board 28, and the spline shaft 30 is able to connect to a not-shown transmission input shaft by a not-shown inner spline. Although the overhang board 28 extends to outer radial direction on the outer diameter side, generally concerns in the outer peripheral convex portion 24-2 of the supporting plate 24 via an axial-direction extending board 26 in the inner diameter side (FIG. 3).

The output member 12 forms recessed parts for containing the respective coil spring sets 14 between the overhang board 28 adjacent to the circumferential direction. The bottom surface of the recessed part is formed by a circumferential surface 24-1 which is one side of the pseudo-triangular shape of the supporting plate 24 that protrudes slightly outward. The guide portion 22 and the recessed part of the overhang board 28 form a window frame-like opening 15 for containing corresponding one of the three coil spring sets 14 with the circumferential surface 24-1.

Next, the detail structure of the torsional vibration reducing apparatus will be explained by exploded perspective views shown in FIGS. 4A and 4B. Three sets of the first retainers 16 and 18 are provided, and each set of the first retainers 16 and 18 has the coil spring set 14 (the each set comprises a low-rigidity first coil spring 32, a high-rigidity second coil spring 34 and an intermediate retainer 36). These three sets are indicated by letters A, B and C, respectively. Moreover, the guide portions 22 of the input members 10 are also provided in pairs, and are therefore represented by adding the signs (A), (B) and (C), respectively. Engaging sections 22-1 and 22-2 are also provided in pairs, and are therefore represented by the signs (A), (B) and (C), respectively. On the other hand, although the overhang boards 28 of the output members 12 form driving sections 28-1 and 28-2 on both end surfaces in the circumferential direction, since the opposing drive sections 28-1 and 28-2 of the overhang boards 28 adjacent to the circumferential direction form the pairs, these are also represented by adding the signs (A), (B) and (C), respectively.

Hereinafter, the each construction of the first retainers 16 and 18 and the each assembled structure of the first retainers 16 and 18 to the input member 10 and the output member 12 will be mainly explained with reference to FIGS. 4A and 4B. However, they will be also explained by referring other groups B and c as appropriate, due to the nature of the perspective views, since all structure cannot thoroughly be illustrated by the group A only.

First, the relationship between the first retainer 16 and the input member 10 will be described below. The first retainer 16 is provided with a guide groove 16-1 (also refer to FIG. 3) extending over the entire circumferential length on its outer circumferential surface facing to the guide portion 22 of a corresponding group (assumed to be the group A) in the input member 10, and the guide groove 16-1 has a (Japanese) letter “ [symbol] ”-shaped cross section opening radially outward, and is contained in the thickness portion of the input member 10 in the guide portion 22 of the input member 10 so as to be slidable in the circumferential direction with an appropriate clearance. Further, the guide portion 22 allows the first retainer 16 to rotate relative to the input member 10 in the circumferential direction, and the engagement of the guide groove 16-1 with the guide portion 22 is substantially free of a backlash in the axial direction without impeding smooth sliding, and functions to axially support the input member 10 of the first retainer 16. Furthermore, the bottom surface of the guide groove 16-1 extending to the circumferential direction can be used as a supporting surface that supports the first retainer 16 at the radial outer side relative to the input member 10.

The first retainer 16 forms a flat surface 16-2 (a pressure receiving section of the present invention) extending radially in parallel with the rotation central line O at the circumferential end portion facing to the adjacent overhang board 28. The flat surface 16-2 makes contact with the opposite end face 28-1 of the overhang board 28 (although the shape of which is difficult to see from FIGS. 4A and 4B, refer to the shape of the circumferentially opposite end face 28-2 of the paired second retainer 18) that is circumferentially adjacent, and the flat surface 16-2 becomes a torque receiving surface from the overhang board 28 during the rotational fluctuations in the forward rotational direction (the arrow f1 direction).

A plate-like projection 16-3 is established integrally from the flat surface 16-2, and the plate-like projection 16-3 extends face-to-face at the outer circumferential surface of the first retainer 16 on the outer circumferential side, but terminates on the way at the inner circumferential side. The plate-like projection 16-3 forms an axial-direction supporting surface 16-4 at the transmission side (the driven side in the present invention) that extends in the radial direction perpendicular to the rotation central line O. In the assembled state, the axial-direction extending board 26 is passed through the radial inside of the plate-like projection 16-3, so that the overhang board 28 makes contact with the axial-direction supporting surface 16-4 at the transmission side in an axially face-to-face manner, and the axial-direction supporting surface 16-4 serves as the axial-direction supporting surface of the first retainer 16 at the transmission side.

A trapezoidal projection 16-5 is established from the flat surface 16-2, spaced from the plate-like projection 16-3 toward the prime mover side (the driving side in the present invention) in the axial direction, and is face-to-face with the outer circumferential surface of the first retainer 16 and the side surface on the prime mover side, but is aligned with the plate-like projection 16-3 and terminates radially inward. A longitudinal groove 16-6 of which the bottom surface is a part of the flat surface 16-2 and which is connected via the guide groove 16-1 on the outer circumferential surface and a curved portion 16-6′, is left between the plate-like projection 16-3 and the trapezoidal projection 16-5. The curved portion 16-6′ of the longitudinal groove 16-6 is provided to match the R-shape of the root of the end face 22-1 of the guide portion 22 opposite to the circumferential direction. That is, in a neutral state without rotational fluctuation, the longitudinal groove 16-6 and the curved portion 16-6′ accommodate the end face 22-1 of the guide portion 22, and at this time, the input member 10 is restricted from rotating relative to the output member 12 by the flat surface 16-2.

An inner peripheral wall 16-14 having a width narrower than the inner diameter surface 16-10 of the inner peripheral portion 16-7, is formed so as to stand upright radially inward over the entire circumferential length. Although the shape of the inner peripheral wall 16-14 is difficult to understand for the first retainer 16 of the group A, its shape can be understood from the first retainers 16 of the groups B and C. The inner peripheral portion 16-7 forms a supporting surface 16-10′ face-to-face with the inner diameter surface 16-10 at the prime mover side of the inner peripheral wall 16-14. When the first retainer 16 is assembled to the input member 10 and the output member 12, the supporting surface 16-10′ is opposite to the circumferential surface 24-1 of the supporting plate 24 from the radially outer side, and the inner peripheral wall 16-14 opposite to the supporting plate 24 from the transmission side in the axial direction. The configuration in which the supporting surface 16-10′ of the first retainer 16 is radially opposite to the circumferential surface 24-1 of the supporting plate 24 and the inner peripheral wall 16-14 is opposite to the transmission side of the supporting plate 24 in the axial direction is also shown in FIG. 3.

The inner peripheral portion 16-7 forms an arc-shaped projection 16-8 established from the flat surface 16-2 at a gap radially inward from the plate-like projection 16-3 and the trapezoidal projection 16-5 on the corresponding overhang board 28 side. That is, the arc-shaped projection 16-8 is an extension of the inner peripheral portion 16-7 on the overhang board 28 side. The arc-shaped projection 16-8 is adapted to penetrate from the inner peripheral side into the axial-direction extending board 26 that connects the supporting plate 24 to the overhang board 28 (FIG. 1 shows how the arc-shaped projection 16-8 penetrates from the inner peripheral side into the axial-direction extending board 26). With this structure, the outer peripheral surface 16-9 of the arc-shaped projection 16-8 becomes a supporting surface that supports the first retainer 16 against the axial-direction extending board 26, i.e., the output member 12, from the radially inner side, and together with the supporting surface from the radially outer side, which is the bottom surface of the guide groove 16-1, a radial-direction supporting structure for the first retainer 16 is provided. In the assembled state, the space between the plate-like projection 16-3 and the arc-shaped projection 16-8 forms a gap for passing the axial-direction extending board 26 of the output member 12. The arc-shaped projection 16-8 forms an axial-direction supporting surface 16-11 on the prime mover side that is perpendicular to the axial direction and extends to the radial direction. In the assembled state (the neutral state), the axial-direction supporting surface 16-11 is opposite and makes contact with the supporting plate 24, and functions as an axial-direction supporting surface of the first retainer 16 on the prime mover side relative to the output member 12. That is, the axial-direction supporting surface 16-11, together with the axial-direction supporting surface 16-4, functions as a supporting surface that supports the first retainer 16 on both sides in the axial direction relative to the output member 12. The abutment structure of the axial-direction supporting surface 16-11 against the supporting plate 24 (the outer peripheral convex portion 24-2) is difficult to understand for the first retainer 16 of the group A, but can be understood from the positional relationship between the axial-direction supporting surface 16-11 of the first retainer 16 of the group B and the outer peripheral convex portion 24-2 of the supporting plate 24. As described above, the arc-shaped projection 16-8 forms the end portion of the inner peripheral portion 16-7 on the corresponding overhang board 28 side, and the axial-direction supporting surface 16-11 of the arc-shaped projection 16-8 presents a circumferential extension that is face-to-face with the inner peripheral wall 16-14.

As shown in FIG. 4A, the first retainer 16 forms a bottomed recess 40 at the circumferential end on the installation side of the flat surface 16-2, i.e., the circumferential end on the abutment side away from the end face 28-1 of the overhang board 28, for containing the first retainer 16 side end of the corresponding coil spring set 14, i.e., the first coil springs 32 and the intermediate retainer 36 and the ends of the second springs 34 close to the intermediate retainer 36. The structure of the bottomed recess 40 for the groups A and B is difficult to see in FIG. 4A, but in the group C, the structure of the bottomed recess 40, which has bottom surfaces 40-1a and 40-2a with different depths and is formed in two stages, a large diameter section 40-1 and a small diameter section 40-2, can be clearly seen. Then, although notch portions 16-13 are formed on both side wall portions of the first retainer 16 from the side adjacent to the coil spring set 14, the notch portions 16-13 can be used as insertion holes against the inside of bottomed recesses 40 of a jig (an assembling robot) that shrinks the springs for the installation at a assembling time. Further, the intermediate retainer 36 also has a supporting projection 36-2 on the inner diameter side, and a visor part 36-3 (which constitutes the second holding part of the present invention for holding (guiding) the second coil spring 34) provided on the outer diameter side so as to face to the second coil spring 34.

The second retainer 18 is the same as the first retainer 16 in the structure for providing a self-contained type supporting structure for the input member 10 and the output member 12, except that it is symmetrically disposed. With reference to the second retainers 18 of the groups A and B, it can be understood that the guide groove 18-1 provides a circumferential sliding structure for the guide portion 22, and that the inner peripheral wall 18-14 is formed upright radially inward from the circumferential inner surface 18-10 of the inner peripheral portion 18-7. Furthermore, with reference to the second retainer 18 of the group C, it can be understood that there are a plate-like projection 18-3 established on the flat pressure-receiving surface 18-2, an axial-direction supporting surface 18-4 formed by the plate-like projection 18-3, a trapezoidal projection 18-5 and a longitudinal groove 18-6 formed therebetween, an arc-shaped projection 18-8 at the tip of the inner peripheral portion 18-7, and an axial-direction supporting surface 18-11 formed by the arc-shaped projection 18-8. In addition, for the second retainer 18 of the group A, the shape of the bottomed recess 42 for containing the end of the second spring 34 and the shape of the notch portions 18-13 formed on both sides can be clearly seen.

The attachment of the first retainers 16 and 18 to the input member 10 and the output member 12 will be explained below. The first retainers 16 and 18 are attached in such a manner that the pin holes 21 of the input member 10 are fitted onto the knock pins of the flywheel 11 to position them, and the first retainers are fixed to the flywheel 11 by the bolts passed through the bolt holes 20, while the output member 12 is fixed to the transmission input shaft by the spline fitting. Since the distance between the circumferential surface 24-1 of the supporting plate 24 of the output member 12 opposite to the guide portion 22 of the input member 10 and the guide portion 22 is maximum at the center between the opposing end faces 28-1 and 28-2 of the pair of circumferentially adjacent the overhang board 28 (refer to FIG. 1 or FIG. 2), by appropriately inclining the first retainer 16 with respect to the input member 10, the first retainer 16 can be introduced between the guide portion 22 and the supporting plate 24 (the window frame-like opening 15) from the step surface 16-10 side, and the guide groove 16-1 can be fitted into the guide portion 22 by straightening the input member 10 and the first retainer 16. Similarly, the second retainer 18 can be introduced into the window frame-like opening 15 from the step surface 18-10 side, and the guide groove 18-1 can be fitted into the guide portion 22. When the first retainers 16 and 18 are fitted into the guide portion 22, the step surfaces 16-10 and 18-10 radially face to the circumferential surface 24-1 of the supporting plate 24, and the inner peripheral walls 16-14 and 18-14 face to the supporting plate 24 in the axial direction from the transmission side. In this connection, the first retainers 16 and 18 are supported upright in the axial direction from the transmission side. When the first retainer 16 already fitted in the guide portion 22 is pushed in the circumferential direction toward the opposite end face 22-1 of the guide portion 22, in the input member 10, the longitudinal groove 16-6 of the first retainer 16 is fitted into the end face 22-1 of the guide portion 22, and in the output member 12, the overhang board 28 is simultaneously engaged with the plate-like projection 16-3 on the transmission side.

Then, the axial-direction extending board 26 is introduced between the trapezoidal projection 16-5 and the arc-shaped projection 16-8, the axial-direction supporting surface 16-11 of the arc-shaped projection 16-8 is made contact with the outer peripheral convex portion 24-2 of the supporting plate 24, and the arc-shaped projection 16-8 is fitted into the axial-direction extending board 26 from the inside. Then, in the final pushing-in completed state, the longitudinal groove 16-6 is fitted into the end face 22-1, and the end face 28-1 of the overhang board 28 is made contact with the flat surface 16-2 of the first retainer 16. In this state, the circumferential inner surface (the bottom surface) 16-10 of the first retainer 16 closely faces to the circumferential surface 24-1 of the supporting plate 24 of the output member 12 (refer to FIG. 3). A similar operation is performed for the second retainer 18, and the flat surface 18-2 of the second retainer 18 comes into contact with the end surface of the overhang board 28 with the end face 22-2 of the guide portion 22 fitted into the longitudinal groove 18-6.

In this state, the circumferential inner surface 18-10 of the second retainer 18 closely faces to the circumferential surface 24-1 of the supporting plate 24 of the output member 12, and the second retainer 18 is supported both axially and radially with respect to the input member 10 and the output member 12. At this time, the notch portions 16-13 and 18-13 are positioned opposite each other between the first retainers 16 and 18 of each group (refer to FIG. 1), and the coil spring set 14 is introduced between the first retainers 16 and 18 by connecting the first coil springs 32 and the second coil springs 34 in series with the intermediate retainer 36, and by shrinking from both sides with the jig and further inserting the jig via the notch portions 16-13 and 18-13. The coil spring set 14 is contained in the bottomed recess 40 of the first retainer at one end under the elasticity by backing the jig and taking away via the notch portions 16-13 and 18-13, and it is possible to obtain the assembled state shown in FIGS. 1 and 2 in which the coil spring set 14 is contained in the bottomed recess 42 of the second retainer at the other end.

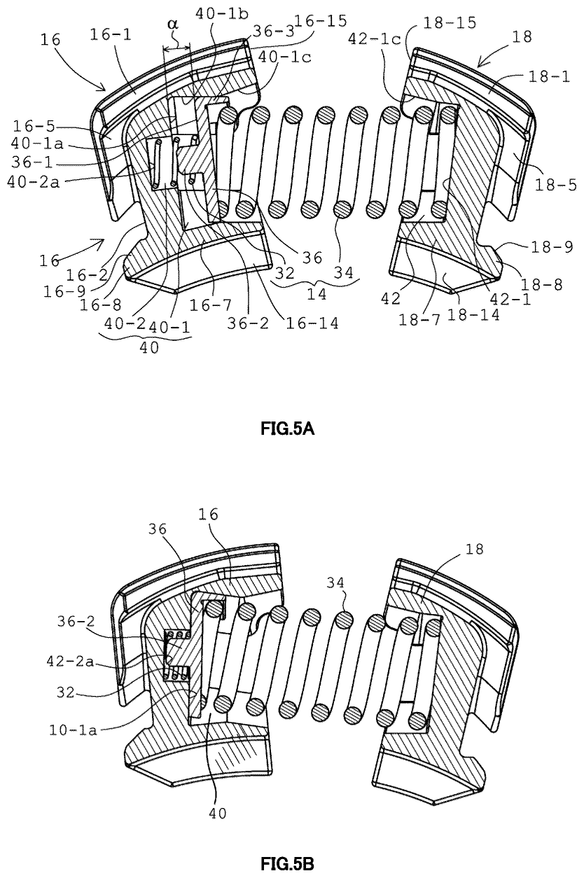

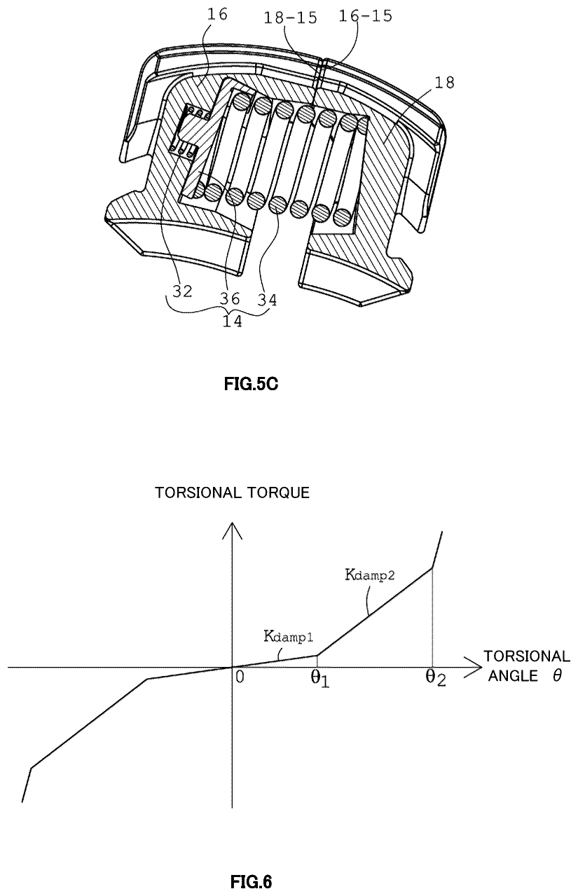

FIG. 5A is a cross-sectional view showing the contained state of one corresponding coil spring set 14 comprising of the first coil spring 32, the second coil spring 34 and an intermediate retainer 36 between a pair of the first retainers 16 and 18 in an initial set state after assembling is completed, by omitting the engagement state of the input member 10 and the output member 12 in order to avoid the complexity. The first coil spring 32 is formed in a short mold using a steel wire with a small wire diameter that can obtain a desired low rigidity (a relatively small torque value relative to the torsional angle), and the second coil spring 34 is configured in a long mold using a steel wire with a large wire diameter to obtain a desired high rigidity (a relatively large torque value relative to the torsional angle). In each coil spring set 14, the end of the first coil spring 32 on the longitudinal side away from the intermediate retainer 36 is accommodated in a bottomed recess 40 of the first retainer, and the end of the second coil spring 34 on the longitudinal side away from the intermediate retainer 36 is contained in the bottomed recess 42 of the second retainer 18.

The containing structure of the first coil springs 32 and the second coil springs 34 by the first retainer 16 and the second retainer 18 will be explained in more detail. The first retainer 16 has the bottomed recess 40 that opens toward the second retainer 18 in the circumferential direction for containing the first coil springs 32 and the intermediate retainer 36, and is formed in two stages with a large diameter section 40-1 extending from the opening end and a small diameter section 40-2 recessed further into a cylindrical shape from the bottom surface of the large diameter section 40-1 (also refer to FIG. 4A for the two-stage shape of the bottomed recess 40). One longitudinal end of the first coil springs 32 is made contact with the bottom surface 40-2a of the small diameter section 40-2, and the other end is made contact with the opposite surface 36-1 of the intermediate retainer 36. In the initial set state, a gap x is remained between the bottom surface 40-1a of the large diameter section 40-1 and the opposite surface 36-1 of the intermediate retainer 36, the deformation of the first coil spring 32 from the initial set state becomes able by the stroke of this gap α, and the second coil spring 34 alone is involved in the suppression of the rotational fluctuation after the gap α disappears. That is, in order to guide the first coil spring 32, the intermediate retainer 36 is provided with a supporting projection 36-2 for the first coil spring 32 at its center which protrudes integrally with the first coil spring 32 toward the inside (together with the small diameter section 40-2 of the bottomed recess 40, this constitutes the first holding part of the present invention for holding (guiding) the first coil spring 32). However, the protruding height of the supporting projection 36-2 from the bottom surface 36-1 is smaller than the size of the gap α between the bottom surfaces 40-1a and 36-1, so that the intermediate retainer 36 seats on the bottom surface 40-1a of the large diameter section 40-1 before the windings of the first coil spring 32 reach close contact with each other, and the intermediate retainer 36 is shifted to the operation by the second coil spring 34 after the first coil spring 32 is deactivated. The configuration in which one end of the first coil spring 32 is inserted into the supporting projection 36-2 and the other end is contained in the small diameter section 40-2 can also be utilized to smoothly deform the first coil spring 32 during the torsional vibration due to its guiding work.

In addition, in order to guide or restrict the deformation of the second coil spring 34, the intermediate retainer 36 has a visor part 36-3 on the radially outer side facing to the second coil spring 34 (refer to FIG. 4B regarding the shape of the visor part 36-3). The first retainer 16 forms a guide surface 40-1b in the bottomed recess 40 with face to the visor part 36-3, and since the second coil spring 34 is urged radially outward by the centrifugal force, the intermediate retainer 36 is guided by the guide surface 40-1b of the first retainer 16 opposed to the visor part 36-3 when the first coil spring 32 is deformed during the rotation fluctuation, thereby to ensure the smooth movement toward the opposite bottom surface 40-1a of the bottomed recess 40. The bottomed recess 40 has an inner peripheral surface 40-1c that is expanded in the axial direction from the guide surface 40-1b to prevent the interference with the second coil spring 34 during the assembling time. The visor part 36-3 holds the end of the second coil springs 34 and also functions as the guide that smoothly guide the intermediate retainer 36 against the inner periphery of the first retainer 16 when the second coil springs 34 are deformed due to the torsional vibration.

As shown in FIG. 5A, the second retainer 18 has a cylindrical bottomed recess 42 that opens to the first retainer 16 side. As shown in the group A of FIG. 4B, the cylindrical bottomed recess 42 has a shape in which both side walls are removed from a cylindrical body, leaving wall portions at the top and the bottom that form arc-shaped inner circumferential surfaces. The end of the second coil spring 34 away from the intermediate retainer 36 is made contact with the bottom surface 42-1 of the cylindrical bottomed recess 42. The radial-direction outer circumferential surface 42-1c of the cylindrical bottomed recess 42 serves as a guide surface for the coil spring 34 against the radial-direction outward displacement due to the second centrifugal force.

The structures of the respective projections, the respective grooves, the respective supporting surfaces, etc. on the opposite outer surfaces of the input member 10 and the output member 12 of the first retainer 16 and the second retainer 18 described in FIGS. 4A and 4B, are indicated by corresponding reference numerals for the parts visible in the cross-sectional views of FIGS. 5A and 5B and the descriptions of their functions are omitted to avoid the duplication.

In the present embodiment, the first retainers 16 and 18 have a so-called self-contained type supporting structure in which the retainers themselves are supported in the axial direction and the radial directions by the input member 10 and the output member 12 without compromising their original functions of holding the coil spring set 14 at the both circumferential ends. That is, in regard to the above supporting structure, the first retainer 16 will be described as follows: as explained with reference to FIG. 4A, the guide groove 16-1 of the first retainer 16 is fitted into the guide portion 22 of the input member 10, and opposite surfaces of the guide groove 16-1 spaced apart in the axial direction are supported in the axial direction by the input member 10. Further, the axial-direction support of the first retainer 16 with respect to the output member 12 is achieved by making contact the overhang board 28 with the plate-like projection 16-3 (the axial-direction supporting surface 16-4) of the first retainer 16 from the transmission side, and by making contact the supporting plate 24 (the outer peripheral convex portion 24-2) with the axial-direction supporting surface 16-11 (formed on the arc-shaped projection 16-8) of the first retainer 16 from the prime mover side. Furthermore, the radial-direction support of the first retainer 16 is achieved by making contact the guide portion 22 of the input member 10 with the bottom surface of the guide groove 16-1 of the first retainer 16 from the radial outside, and by making contact the outer peripheral surface 16-9 of the arc-shaped projection 16-8 with the inner peripheral surface of the axial-direction extending board 26 of the output member 12 from the radial inside.

The second retainer 18 is also supported in the same manner with respect to the input member 10 and the output member 12. That is, the second retainer 18 is axially supported by the input member 10 via the contact with the axial-direction opposite-side surfaces of the guide groove 18-1, and the second retainer 18 is axially supported with respect to the output member 12 between the plate-like projection 18-3 (the axial-direction supporting surface 18-4) and the arc-shaped projection 18-8 (the axial-direction supporting surface 18-11). Further, the support of the second retainer 18 is performed by making the guide portion 22 of the input member 10 contact with the bottom surface of the guide groove 18-1 of the second retainer 18 from the radial-direction outer side, and by making the outer circumferential surface 18-9 of the arc-shaped projection 18-8 contact with the axial-direction extending board 26 of the output member 12 from the radial-direction inner side.

Since the first retainers 16 and 18 have the self-contained type supporting structure for the input member 10 and the output member 12, both the input member 10 and the output member 12 are one-piece press-formed products made of the steel plate. Nevertheless, the first retainer 16 is supported by the input member 10 and the output member 12 in both the axial direction and the radial directions, and the original function of the first retainers 16 and 18 to hold the coil spring set 14 is not impaired. Further, at least one press-formed part can be saved in comparison with the conventional configuration in which the input member 10 is made of two sheets and the coil spring set 14 is held between them, and rivets are not required to integrate the two sheets, which also reduces the number of parts and is advantageous in terms of workability. Furthermore, the absence of the rivets allows for greater freedom in the design on the outer diameter side.

Next, the rotational fluctuation suppressing operation of the torsional vibration reducing apparatus of the first embodiment will be described with reference to FIGS. 4A and 4B.

When the output member 12 generates the torsional torque in the forward rotational direction (an arrow f1 direction) relative to the input member 10, the end face 28-1 of the overhang board 28 makes contact with the opposite flat surface 16-2 of the first retainer 16 (a retainer located at the upstream in the torsional-torque application direction), causing the first retainer 16 to slide in the arrow f1 direction along the guide portion 22 via the guide groove 16-1, and then the first retainer 16 is released from the contacting state with the end face 22-1 of the guide portion 22. On the other hand, since the flat surface 18-2 of the second retainer 18 being the other pair maintains the contacting state with the guide-portion end face 22-2 at the downstream side in the rotational fluctuation direction, the end face 28-2 of the overhang board 28 at the downstream side in the rotational fluctuation direction is released from the opposite flat surface 18-2 of the second retainer 18, and the first retainer 16 arouses the further compression of the coil spring set 14 between the input member 10 and the output member 12. Based on the increasing of the torsional torque in the forward rotational direction (the arrow f1 direction) of the output member 12 relative to the input member 10, the overhang board 28 at the downstream side in the rotational fluctuation direction f1 of the output member 12 is eventually released from the second retainer 18 (the longitudinal groove 18-6) and the axial-direction extending board 26 is released from the arc-shaped projection 18-8 (the circumferential-direction circumference surface 16-9). At this time, since the second retainer 18 is elastically engaged with the guide-portion end face 22-2 at the flat surface 18-2, the second retainer 18 is held and fixed to the input member 10. In addition, the radial-direction outward component of the elastic force generated in the coil spring set 14 and the centrifugal force generated in the second retainer 18 by the rotation of the crank shaft also contribute to securely holding the second retainer 18 relative to the input member 10.

Conversely, when the output member 12 undergoes a rotational fluctuation in the reversing direction (an arrow f2 direction) from the neutral state relative to the input member 10, the end face 28-2 of the overhang board 28 makes contact with the flat surface 18-2, causing the second retainer 18 (a retainer located at the upstream in the torsional-torque application direction) to slide in the reverse direction (the arrow f2 direction) along the guide portion 22 via the guide groove 18-1, and at this time the flat surface 18-2 of the second retainer 18 is released from the contacting state with the end face 22-2 of the guide portion 22. Since the flat surface 16-2 of the paired first retainer 16 located at the downstream in the direction of the rotational fluctuation is engaged and held by the end face 22-1 of the guide portion 22, the end face 28-1 of the overhang board 28 is separated from the first retainer 16 and the second retainer 18 is slid along the guide portion 22 toward the first retainer 16 which faces it in the circumferential direction via the guide groove 18-1, and the spring set 14 slides, and the further compression of the coil spring set 14 is aroused. Thus compression action of the coil spring set 14 in accordance with the direction of the rotational fluctuation makes it possible to realize the reduction of the rotational fluctuation.

The operation of the coil spring set 14 in the present embodiment in response to the torque changes will be explained. In a state (the neutral state) where no torsional torque is applied, the paired first retainers 16 and 18 made by the elastic force of the first coil springs 32 and second coil springs 34 in the coil spring set 14 connected in series via the intermediate retainer 36 are made contact with the closely opposed engaging sections 22-1 and 22-2 of the guide portion 22 of the input member 10 and the closely opposed driving sections 28-12 and 28-2 of the overhang board 28 of the output member 12 (FIGS. 1 and 2). The state of the coil spring set 14 in a state where no fluctuating torque is applied (the torsional torque=0) is shown in FIG. 5A.

Although the torque fluctuation in the forward rotational direction (the arrow f1 in FIG. 1) acting between the input member 10 and the output member 12 is aroused the movement of the first retainer 16 toward the second retainer 18 and the torque in the reversing direction (the arrow f2 in FIG. 1) is aroused the movement of the second retainer 18 toward the first retainer 16, this makes the intermediate retainer 36 slide along the inner diameter of the first retainer 16 in a state that the torque is small. The torque that arouses the sliding of the intermediate retainer 36 and first retainer 16 is set to a low torque such as the idle operating range of the prime mover. Such sliding of the intermediate retainer 36 is obtained when the intermediate retainer 36 has a gap with respect to the opposite bottom surface 40-1a as shown in FIG. 5A. In this case, by assuming that coefficients “k₁” and “k₂” are respectively the spring stiffness of the first coil spring 32 and the second coil spring 34, the torsional stiffness value “K_{damp1}” due to the first coil spring 32 and the second coil spring 34 is expressed as “K_{damp1}=k₁k₂/(k₁+k₂)”.

The increasing of the relative movement in the circumferential direction between the first retainers 16 and 18 based on the torque based on that the drive enters into the driving range at the rated torque due to the torque increasing from the idle operating range, eventually causes the intermediate retainer 36 to seat on the opposite bottom surface 40-1a as shown in FIG. 5B and the first coil spring 32 loses its function as a spring. The relative movement in the circumferential direction between the first retainers 16 and 18 due to the further torque increasing is performed only against the elastic force of the second coil spring 34, and the torsional stiffness value “K_{damp2}” at this time can be expressed as “K_{damp2}=K₂”. In order to disable the first coil spring 32 prior to the intermediate retainer 36 seating on the seating surface 40-1a (to prevent the adhesion (the complete crushing) of the first coil spring 32), the intermediate retainer 36 is seated on the seating surface 40-1a before the supporting projection 36-2 on the inner diameter side of the intermediate retainer 36 comes into contact with the opposite surface 42-2a, so as to prevent the first coil spring 32 from becoming adhered (completely crushed).

FIG. 5C shows a state in which the opposite surfaces of the first retainers 16 and 18 come into contact with each other due to the further increasing of the torsional torque, and at this time the second coil spring 34 also loses its function. At this time as well, the opposite surfaces 16-15 and 18-15 on the outer diameter sides of the first retainers 16 and 18 are designed to come into contact with each other before the second coil spring 34 comes into close contact (complete crushing).

Note that in FIGS. 5B and 5C, only the relevant part numbers are shown to avoid the complication.

FIG. 6 is a graph showing a schematic relationship between the torsional angle and the torsional torque. In the region where the relative torsional angle is smaller than the gap α(θ<θ₁), the first coil spring 32 and the second coil spring 34 operate in series to damp the vibration of the fluctuating torque transmitted from the input member 10.

In the rated torque region (θ₁<θ<θ₂) where the relative torsional angle due to the torque fluctuation becomes larger than the gap α, the gap α between the intermediate retainer 36 and the first retainer 16 is completely eliminated, and the bottom surface 40-1a of the bottomed recess 40 of the first retainer 16 comes into contact with the bottom surface 36-1 of the intermediate retainer 36 (FIG. 5B). Since the first coil spring 32 is contained in the containing section of the first retainer 16 in a compressed state that does not reach close contact, there is no bottoming out in the operation.

In the region where the fluctuating torque is at it's the maximum (θ>θ₂), the opposite surface 16-15 provided on the upper part of the first retainer 16 and the opposite surface 18-15 provided on the upper end of the second retainer 18 on the first retainer side come into contact (FIG. 5C), the excessive torque is dispersed and the effects of the bottoming out of the second coil spring 34 is mitigated.

In the operation of the coil spring set 14 in response to the torque changes as described above, since the first retainer 16 is made of the resin and the contact is metal-to-resin if the intermediate retainer 36 is made of the metal as described above, the shock caused by the intermediate retainer 36 coming into contact with the first retainer 16 (the bottom surface 40-1a) when transitioning from the low torque to the normal torque can be suppressed so that it does not become an abnormal noise that is noticeable to the driver. Further, if the intermediate retainer 36 is also made of the resin by appropriately selecting the material and thickness, the contact will be resin-to-resin and further reduction in the abnormal noise is possible.

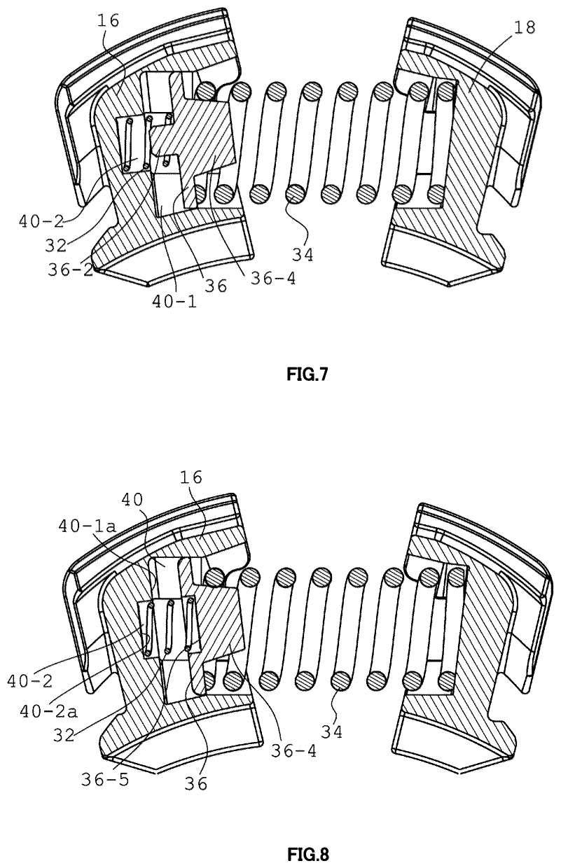

FIG. 7 shows the intermediate retainer 36 of another embodiment, which does not have the visor part 36-3 of the first embodiment, but has a conical pedestal-shaped portion 36-4 (constituting the second holding portion of the present invention) instead, and the conical pedestal-shaped portion 36-4 is inserted into the central opening of the second coil spring 34 from the side of the first coil spring 32. That is, in this embodiment, the intermediate retainer 36 is structured so that the conical pedestal-shaped portion 36-4 supports the end of the second coil spring 34 from the inner diameter side.

In this embodiment, one end of the first coil spring 32 is contained and guided in the supporting projection 36-2 provided on the intermediate retainer 36 on the side adjacent to the first coil spring 32, and the guide structure comprising of the supporting projection 36-2 provided on the intermediate retainer 36 and the small diameter section 40-2 in the bottomed recess 40 of the first retainer 16, as well as the disabling mechanism for the first coil spring 32 by keeping the supporting projection 36-2 out of contact with the opposite surface when the intermediate retainer 36 is seated, are the same as those in the first embodiment (FIGS. 5A to 5C). The configuration of the recess for containing the second coil spring 34 by the second retainer 18 is the same as in the first embodiment, the detailed description will be omitted. Furthermore, the supporting structure for the input member and/or output member formed on the outer surfaces of the first and second retainers 16 and 18 and provided by the face-to-face opposition and the groove-to-projection fitting is similar to that of the first embodiment, but the description of the structure will be omitted.

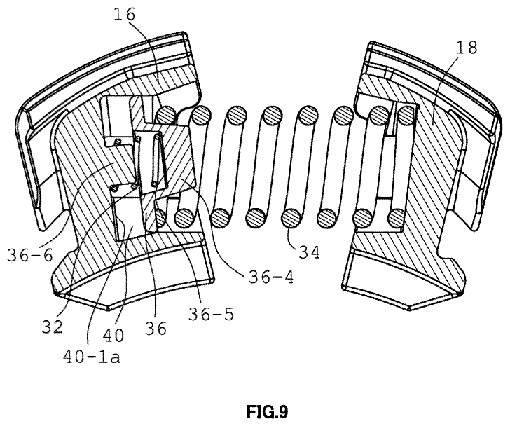

FIG. 8 shows another embodiment, in which an intermediate retainer 36 has a similar configuration in which it is provided with the conical pedestal-shaped portion 36-4 for containing the second coil spring 34, but one end is contained in the recess 36-5 of the intermediate retainer 36 to guide the first coil spring 32, and the other end is contained in the small diameter section 40-2 in the bottomed recess 40 of the first retainer 16 (together with the recess 36-5 forms the first holding part of the present invention). In the same configuration, the first retainer 16 is seated on the opposite surface 40-1a of the small diameter section 40-2 in the bottomed recess 40 to deactivate the first coil spring 32 before it comes into close contact with the first coil spring 32.

FIG. 9 shows an intermediate retainer 36 of still another embodiment, which has the same configuration as FIGS. 7 and 8 in that it is provided with the conical pedestal-shaped portion 36-4 provided on the side adjacent to the second coil spring for supporting the end of the second coil spring. The difference is that in order to guide the first coil spring 32, the intermediate retainer 36 is provided with the recess 36-5 for containing one end of the first coil spring 32 on the side away from the second coil spring 34, and the projection 36-6 for containing the other end of the first coil spring 32 is provided on the bottom surface of the bottomed recess 40 of the first retainer 16. In this embodiment, too, the projection 36-6 is set to a length such that the first coil spring 32 does not bottom out when seated on the opposite surface 40-1a of the bottomed recess 40 of the intermediate retainer 36 (which together with the projection 36-6 constitutes the first holding part of the present invention).

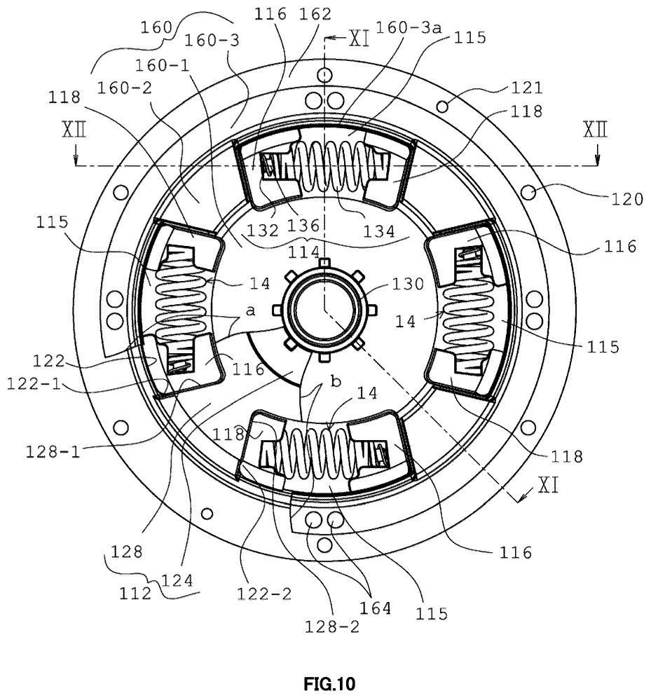

FIGS. 10 to 13 show a torsional vibration reducing apparatus according to a second embodiment of the present invention, and show a means of realizing the present invention for a type that has a normal retainer supported by an input member instead of the self-contained supporting-type retainer in the first embodiment.

The input member 110 has four window frame-like openings 115 spaced at the equal intervals in the circumferential direction, and a coil spring set 114 is housed in each window frame-like opening 115. As in the first embodiment, each coil spring set 114 is configured by connecting in series the first coil spring 132 (the first elastic member of the present invention) having a low rigidity and a short length and the second coil spring 134 (the second elastic member of the present invention) having a high rigidity and a long length via an intermediate retainer 136 (a connecting member of the present invention). The first retainer 116 and the second retainer 118, which are injection-molded synthetic resin products for containing both ends of the coil spring set 114, are disposed in each window frame-like opening 115.

FIG. 13 shows the arrangement of the coil spring set 114 relative to a pair of the first retainer 116 and the second retainer 118, and similarly to the first embodiment, the first retainer 116 has a bottomed recess 140 for containing the first coil spring 132 and the intermediate retainer 136, and the second retainer 118 has a bottomed opening 142 for containing the second coil spring 134. In this embodiment, as described above, the first retainer 116 and the second retainer 118 are supported in the axial direction and the radial direction by the input member 110, and therefore the outer circumferential surfaces of the first retainer 116 and second retainer 118 are completely flat, and as is clear from a comparison with the first retainers 16 and 18 in the first embodiment in FIGS. 5A to 5C, they are not provided with engaging portions for self-retaining operation such as the projections or the guide grooves.

As shown in FIG. 11, the input member 110 has a combined structure of a pair of main body plates 160 and an outer peripheral disk 162 spaced apart in the axial direction and joined together by rivets 164, and the outer peripheral disk 162 of the input member 110 is connected to the flywheel (on the prime mover side) by a knock pin and a bolt fastening, similar to the first embodiment, and in FIG. 10 the bolt holes are respectively indicated by “120” and the knock pin holes by “121”. Each of the two main body plates 160 in the input member 110 has, as shown in FIG. 10, a structure in which a central supporting plate portion 160-1 is connected by an outer peripheral disk portion 160-3 via overhang plate portions 160-2 spaced with the equal intervals in the circumferential direction.

In FIG. 10, the upper main body plate 160 of the pair of main body plates 160 of the input member 110 is cut out at a portion between the cutting lines “a” and “b”, and the output member 112 is visible between the cut lines “a” and “b”. As in the first embodiment, the output member 112 has a central supporting plate 124 and overhang boards 128 arranged with the intervals in the circumferential direction on the outer periphery of the supporting plate 124. The number of overhang boards 128 is four as in the first embodiment, but the overhang boards 128 are configured to extend radially outward as they are, which is different from the first embodiment (there is no portion corresponding to the axial-direction extending board 26 in the first embodiment).

As shown in FIG. 11, the output member 112 is arranged so as to be sandwiched between the main body plates 160 of the input member 110 from the both sides in the axial direction, and the central spline shaft 130 is spline-fitted to the input shaft of the transmission. In the set state of the damper of this embodiment shown in FIG. 10, the overhang board 128 is arranged so as to overlap vertically with the overhang plate portion 160-2 of each of the two main body plates 160 that make up the input member 110. Although this state cannot be seen directly from FIG. 10, it can be understood from the arrangement of the overhang board 128 in the cut-out portion between the cutting lines “a” and “b”.

Although the method of supporting the first retainer 116 and the second retainer 118 in the radial direction and the axial direction by the input member 110 is a known structure, the structure will be simply explained below. The radial support of the first retainer 116 and the second retainer 118 to the input member 110 is performed by making contact with the radially outer side and the radially inner side of the window frame-like opening 115 corresponding to the input member 110. Also, in order to support the first retainer 116 and the second retainer 118 in the axial direction, the outer peripheral disk portion 160-3 of the main body plate 160 of the input member 110 forms visor parts 160-3a provided along the opposite surfaces of the first retainer 116 and the second retainer 118 on both sides in the axial direction at the outer peripheral edge of the window frame-like opening 115. As seen from FIG. 11, the visor-like supporting portions 160-3a are arranged along the sliding range of the first retainer 116 and the second retainer 118, and the first retainer 116 and the second retainer 118 are extended so as to cover somewhat from both axial sides, thereby ensuring support of the first retainer 116 and the second retainer 118 on both axial sides. In this way, the first retainer 116 and the second retainer 118 are supported in the radial direction and the axial direction, and the first retainer 116 and the second retainer 118 can move along the window frame-like opening 115 without falling off.

In FIG. 13, the configuration of one coil spring set 114 in the window frame-like opening 115 is similar to that of the coil spring set 14 of the first embodiment, and the coil spring set 114 is composed of the first coil spring 132, the second coil spring 134 and an intermediate retainer 136. The first retainer 116 has a bottomed recess 140 for containing the first coil spring 132 and the intermediate retainer 136, and the bottomed recess 140 is formed in two stages by a large diameter section 140-1 and a small diameter section 140-2 from the opening end. One end of the first coil spring 132 makes contact with a bottom surface 140-2a of the small diameter section 140-2, and the other end makes contact with an opposite surface 136-1 of the intermediate retainer 136. The gap left between the bottom surface 140-1a of the large diameter section 140-1 and the opposite surface 136-1 of the intermediate retainer 136 in the initial set state, is made slightly larger than the height of the projection 136-2 of the intermediate retainer 136 inserted into the first coil spring 132 to hold the first coil spring 132. Therefore, when the amount of the movement between the first retainer 116 and the second retainer 118 is small, the first coil spring 132 and the second coil spring 134 work in series, resulting the in low rigidity overall.

After the intermediate retainer 136 is seated on the opposite surface 140-1a of the first retainer 116, the second coil spring 134 alone provides the high rigidity in terms of suppressing rotational fluctuations. The intermediate retainer 136 also has a visor part 136-3 on the radial-direction outer side. The visor part 136-3 not only holds the ends of the second coil springs 134, but also helps the intermediate retainer 136 to slide smoothly in response to the deformation. Further, the second retainer 118 has a cylindrical bottomed opening 142 that opens to the first retainer 116 side. The ends of the second coil springs 134 away from the intermediate retainer 136 make contact with a bottom surface 142-1 of the cylindrical bottomed opening 142.

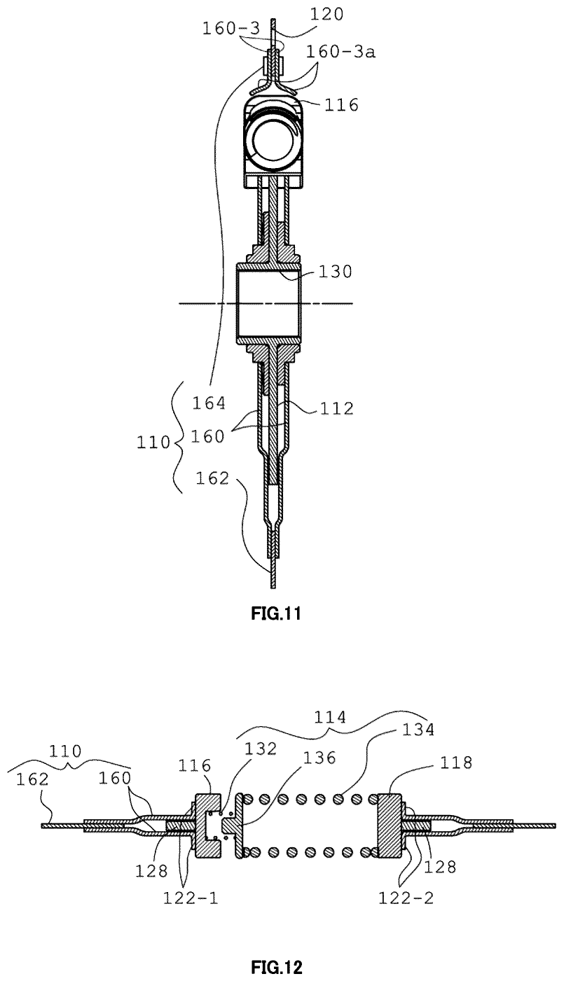

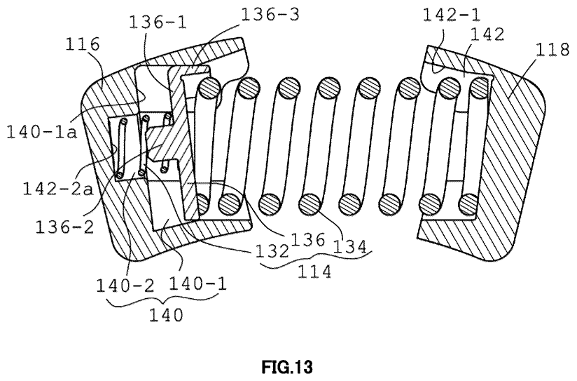

The sliding action of the first retainer 116 and the second retainer 118 during the rotational fluctuation in the window frame-like opening 115 will be explained below. Although the inner-circumferential arcuate surfaces of the two main body plates 160 constituting the input member 110 become the guide portions 122 (corresponding to the guide portions 22 in the first embodiment) of the first retainer 116 and the second retainer 118, this can only be seen in the cut portion between the cutting lines “a” and “b”. The angular range of the guide portions 122 is the same as that of the guide portions 22 in FIG. 4A, but FIG. 10 shows the upstream engaging section 122-1 and the downstream engaging section 122-2 of the adjacent guide portion 122 (also refer to FIG. 12). The engaging sections 122-1 and 122-2 are integral parts of the main body plates 160 to constitute the input member 110.

The operation of the first retainer 116 and the second retainer 118 during the torsional vibration is the same as in the first embodiment. In the no-torque state, the first retainer 116 and the second retainer 118 suppress the rotational fluctuation by arousing the deformation under the elasticity of the coil spring set 114 that makes contact with closely opposing engaging sections 122-1 and 122-2 of the guide portion 122 and closely opposing drive portions 128-1 and 128-2 of the overhang board 128. The suppression of the rotational fluctuation under the low torsional rigidity due to the serial operation of the first coil spring 132 and the second coil spring 134 constituting the coil spring set 114 during the low torque and under the high torsional rigidity when the first coil spring 132 is disabled (to prevent the bottoming out) during the rated torque, is the same as in the first embodiment. That is, FIG. 13 shows the state of the coil spring set 114 between the first retainer 116 and the second retainer 118 in the no-torque state.

The increasing of the torsional torque between the first retainer 116 and the second retainer 118 causes the elastic deformation under the low torsional rigidity in the series arrangement of the first coil spring 132 and the second coil spring 134. Consequently, it is possible to surely obtain the operating noise reduction during the low torque operation such as in the idle driving range by widening the low torsional rigidity with the series arrangement.

The increasing of the torsional torque makes the intermediate retainer 136 to seat on the opposite surface 140-1a of the large diameter section 140-1 of the bottomed recess 140 on the first retainer 116 and to deactivate the first coil spring 132. In the initial set state, since the length of the projection 136-2 of the intermediate retainer 136 is set to a clearance between the intermediate retainer 136 and the opposite surface 140-1a, the first coil spring 132 does not bottom out at a deactivated time. Accordingly, it is possible to protect the first coil spring 132.

In this way, after the transition from the low torque operation to the rated torque operation range, the vibration damping action is performed under the high torsional rigidity by the second coil spring 134 alone.

In the second embodiment, it is also possible to form a window frame-like opening 115 in the output member 112 for supporting the first retainer 116 and the second retainer 118. In this case, the output member has a matching structure of two plates spaced apart in the axial direction, and the one-piece input member 110 is disposed between the two plates of the matching structure.

In the above embodiments and modified examples, only one end of the spring sets 14 and 114 is configured to connect the short first coil springs 32 and 132 to the long second coil springs 34 and 134 and to have the intermediate retainers 36 and 136 that slide on the first retainers 16 and 116. However, it is also possible to have a configuration (not shown) in which a short spring and a short spring are connected to a long spring at the other end of the spring sets 14 and 114, i.e., at both ends, and an intermediate retainer that slides on the second retainers 18 and 118 is provided. Such a configuration has the advantage that the torsional angle can be dispersed to ensure the wider torsional angle in the low rigidity region, and the sliding distance of each intermediate retainer can be relatively shortened.

Furthermore, the short first coil springs 32 and 132 (the first elastic members of the present invention) can be replaced by the disc springs, one end of which is arranged to make contact with the bottom surface of the bottomed recess of the first and/or second retainer, and the other end of which is arranged to make contact with the intermediate retainer.

### EXPLANATION OF REFERENCE NUMERALS

10; 110 . . . input member
12; 112 . . . output member
14; 114 . . . coil spring set
16, 18 . . . retainer
   16-1, 18-1 . . . guide groove
   16-2, 18-2 . . . flat surface
   16-3, 18-3 . . . plate-like projection
   16-4, 18-4 . . . axial-direction supporting surface
   16-5, 18-5 . . . trapezoidal projection
   16-6, 18-6 . . . longitudinal groove
   16-7, 18-7 . . . inner peripheral portion
   16-8, 18-8 . . . arc-shaped projection
   16-11, 18-11 . . . axial-direction supporting surface
   16-14,18-14 . . . inner peripheral wall
22; 122 . . . guide portion
   22-1, 22-2; 122-1, 122-2 . . . end face of guide portion
24; 124 . . . supporting plate
   24-1; 124-1 . . . circumferential surface of supporting plate
28; 128 . . . overhang board
   28-1, 28-2; 128-1, 128-2 . . . pressurization section of overhang board
30; 130 . . . spline shaft
32 . . . first coil spring
34 . . . second coil spring
36 . . . intermediate retainer
   36-2 . . . supporting projection
   36-3 . . . visor part
   36-4 . . . conical pedestal-shaped portion
40 . . . bottomed recess of the first retainer
   40-1 . . . large diameter section
   40-1a . . . bottom surface of large diameter section
   40-2 . . . small diameter section
   40-2a . . . bottom surface of small diameter section
42 . . . bottomed recess of the second retainer
42-1 . . . bottom surface
O . . . rotation central line

1. A torsional vibration reducing apparatus that comprises an input member for rotating and connecting to a driving side, an output member having a rotation central line with said input member and for rotating and connecting to a driven side, and an elastic body arranged in a circumferential direction between said input member and said output member; and reduces a rotational fluctuation based on an elastic deformation of said elastic body in said circumferential direction at a time of driving of said output member on said driven side by said input member of said driving side:
wherein one of said input member and said output member comprises guide portions, arc-extending, which is faced to said elastic body from outside and has said rotation central line of said input member and said output member, another of said input member and said output member comprises a center supporting plate and overhang boards extending between said elastic body adjacent to said circumferential direction of said supporting plate and said elastic body, said respective guide portions form an engaging portion extended in diameter inside on both circumferential direction ends, and respective overhang boards form a pressurization section extended in diameter outside on said both circumferential direction ends;
wherein said torsional vibration reducing apparatus further comprises supporting structures in an axial direction and a radial direction to said input member and/or said output member arranged in circumferential direction ends of said respective elastic bodies, and retainers being movable to said circumferential direction along said guide portions; said retainers have bottomed recesses for respectively containing opposite ends to said circumferential direction of said elastic bodies, and said retainers are opposed and arranged to said engaging portions adjacent to said guide portions and pressurization sections adjacent to said overhang boards in pressure receiving sections which are side ends separated from said bottomed recess in said circumferential direction;
wherein said elastic body comprises a low-rigidity first elastic member, a high-rigidity second elastic member and an intermediate member for connecting said first elastic member and said second elastic member in series with regard to at least one end of said retainers, and said first elastic member, said intermediate member and side ends adjacent to intermediate member of said second elastic member are contained in said bottomed recesses of said corresponding retainers, and said intermediate member is slidably supported to an opposite surface in a radial direction of said bottomed recess of said retainers; and
wherein in said retainers being a pair, said retainer located at an upstream in a torque transmission direction is circumferentially moved, by making contact with said pressurization section adjacent in said circumferential direction, along said guide portion toward said retainer located at a downstream in said torque transmission direction and engaged with said engaging portion adjacent to said guide portion, against a low elastic force based on a serial combination of an elastic modulus of said first elastic member and an elastic modulus of said second elastic member in a transmission torque range lower than a rated use, and against a high elastic force based on said high elastic modulus of said second elastic member alone in a rated transmission torque range.

2. The torsional vibration reducing apparatus according to claim 1, wherein said first elastic member and said second elastic member are configured as a first coil spring and a second coil spring respectively; and comprise a first holding part doing said holding of said first coil spring without bottoming out before transitioning to said second coil spring sole operation, and a second holding part holding side ends adjacent to said first coil spring of said second coil spring when sliding said retainer of said intermediate member on a series and standalone operations.

3. The torsional vibration reducing apparatus according to claim 2, wherein said first holding part comprises a small diameter portion formed on a center portion in a bottom surface of said bottomed recess of said retainer and contained one end of said first coil spring from outer diameter side, and a projection formed on said second coil spring separation surface of said intermediate member and inserted into another end of said first coil spring.

4. The torsional vibration reducing apparatus according to claim 2, wherein said first holding part comprises a small diameter portion formed on a center portion in a bottom surface of said bottomed recess of said retainer and contained one end of said first coil spring from outer diameter side, and a recess formed on said second coil spring separation surface of said intermediate retainer and contained another end of said first coil spring.

5. The torsional vibration reducing apparatus according to claim 2, wherein said first holding part comprises a projection formed on a center portion in a bottom surface of said bottomed recess of said retainer and inserted into one end of said first coil spring from outer diameter side, and a recess formed on said second coil spring separation surface of said intermediate retainer and contained another end of said first coil spring.

6. The torsional vibration reducing apparatus according to claim 2, wherein said second holding part holds said second coil spring in said first coil spring separation side of said intermediate member by making contact on said inner diameter portion in said first coil spring near side end of said second coil spring, and is a visor which is slidably made contact with inner surface of said bottomed recess of said retainer in said circumferential direction.

7. The torsional vibration reducing apparatus according to claim 2, wherein said second holding part is a conical pedestal-shape projection inserted into a center opening portion of said second coil spring in said first coil spring separation side of said intermediate retainer.

8. The torsional vibration reducing apparatus according to any one of claims 1 to 7, wherein at least said first retainer and said second retainer out of said intermediate retainer, said first retainer and said second retainer are moldings made by injection molding as a material of synthetic resin.

9. The torsional vibration reducing apparatus according to any one of claims 1 to 7, wherein said supporting structure is formed on opposite-face surfaces between said input member and said output member of said first retainer and said second retainer and is constituted as a self-contained type supporting structure made by a groove-projection fitting structure and a surface-surface contacting structure for supporting said first retainer and said second retainer themselves in said axial direction and said radial direction to said input member and said output member, and wherein relative displacements of said input member and said output member according to rotational fluctuation arouse relative displacements in said circumferential direction according to elastic force between said first retainer and said second retainer.

10. The torsional vibration reducing apparatus according to any one of claims 1 to 7, wherein said supporting structure is configured as an axially aligned structure of multiple plates in which one of said input member and said output member is disposed between said other of said input member and said output member in order to support said first retainer and said second retainer in said axial direction and said radial direction, and wherein relative displacements of said input member and said output member according to rotational fluctuation arouse relative displacements in said circumferential direction according to elastic force between said first retainer and said second retainer.
